(19) United States
(12) Patent Application Publication
(10) Pub. No.: US 2002/0140963 A1
(43) Pub. Date: Oct. 3, 2002

(54) Printer, print control apparatus, power control method, memory medium, and program

(75) Inventor: Kuniaki Otsuka, Kanagawa (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/098,428

(22) Filed: Mar. 18, 2002

(30) Foreign Application Priority Data
Mar. 19, 2001 (JP) 079170/2001
Mar. 13, 2002 (JP) 068822/2002

(51) Int. Cl. B41F 1/00; G06F 15/00

(52) U.S. Cl. 358/1.14

(57) ABSTRACT

An information terminal apparatus existing in a range where communication can be made by a wireless data transmission system by a communication processor is inquired together with a kind of function. The function kind included in a response from the information terminal apparatus to the inquiry is analyzed, and if the information terminal apparatus having a printing profile is not confirmed as a result of the analysis, an operating mode is shifted to a power saving mode.

### BACKGROUND OF THE INVENTION

1. Field of the Invention

The invention relates to a printer comprising: a communication processor for making data communication with an information terminal apparatus by a predetermined wireless data transmission system by a power source which is supplied from a power supply; a data processor for processing print data received by the communication processor; and an engine for printing the data processed by the data processor. The invention also relates to a power control method of the printer, a memory medium, and a program.

2. Related Background Art

In recent years, environmentally aware techniques have been remarkably progressed in various technical fields. As one of them, an energy saving technique in printers can be mentioned. As such a technique, the invention such that in a portable printer, a power saving process is executed on the printer side in the case where print data is not inputted from an upper apparatus to the printer for a predetermined time has been disclosed in Japanese Patent Application Laid-open No. 05-342388. The invention such that a printer is started automatically in an interlocking relational manner with a host computer activated (power ON) on a network and the printer is stopped automatically in an interlocking relational manner with the power OFF of the host computer has been disclosed in Japanese Patent Application Laid-open No. 09-190246. A mechanism such that peripheral apparatuses are sensed in a wireless manner, whether there is an apparatus having a possibility to send data to the apparatus itself or not is discriminated, and a control to turn off a power source or shift an operating mode to a sleep status of the power source is made in accordance with a result of the sensing operation has also been disclosed in Japanese Patent Application Laid-open No. 09-081278.

In recent years, computer techniques and communicating techniques have also been remarkably progressed. Particularly, wireless communicating techniques such as “IEEE 802. 11b”, “Bluetooth” (registered trademark), and the like have been strikingly progressed. Household appliances, office machines such as printers, and the like corresponding to such wireless techniques are also being spread.

In case of presuming transmission of print data using wireless communication, however, a terminal apparatus having a function for allowing the printer to execute the printing operation is not always a predetermined apparatus, but there is a possibility that such an apparatus varies irregularly, and such a situation has not been presumed hitherto.

Further, various kinds of electronic apparatuses having the wireless communicating function are presumed and not all of the electronic apparatuses which can communicate with the printer in a wireless manner have the function for allowing the printer to execute the printing operation. In the conventional printers, the function for properly executing the energy saving process in correspondence to such various kinds of electronic apparatuses is not realized.

Although a mechanism for a power control in a wireless printer has been disclosed in Japanese Patent Application Laid-open No. 09-081278, there is still a room for improvement in terms of a point that the printer copes flexibly with ambient environments of the printer itself.

The invention is made to solve the foregoing problems. In a printer which can communicate with an information terminal apparatus which can make wireless communication, it is an object of the invention to provide a printer which can largely reduce an electric power consumption in correspondence to various ambient environments, and to provide a power control method of the printer, a memory medium, and a program.

### SUMMARY OF THE INVENTION

According to an embodiment of the invention, in order to realize a mechanism for remarkably reducing an electric power consumption in correspondence to various ambient environments, there is provided a printer having a communication processor for making data communication with an information terminal apparatus by a predetermined wireless data transmission system and a print processor for printing and outputting print data received by the communication processor, comprising: means for inquiring the information terminal apparatus existing in a range where the communication can be made by the wireless data transmission system by the communication processor together with a kind of function; and means for controlling a power supply status of a power source which is supplied to the print processor in accordance with the function kind included in a response from the information terminal apparatus to the inquiry by the inquiry means.

The above and other objects and features of the present invention will become apparent from the following detailed description and the appended claims with reference to the accompanying drawings.

### BRIEF DESCRIPTION OF THE DRAWINGS

FIG. 1 is a block diagram for explaining a construction of a printer showing the first embodiment of the invention;

FIG. 2 is a block diagram showing an example of an information terminal apparatus according to the embodiment of the invention;

FIG. 3 is a diagram showing a print processing system to which the printer according to the invention can be applied;

FIG. 4 is a diagram for explaining an example of a layer structure of data processes which are applied to the printer according to the invention;

FIG. 5 is a flowchart showing an example of a first data processing procedure in the printer according to the invention;

FIG. 6A is a flowchart showing an example of the first data processing procedure in the printer according to the invention;

FIG. 6B is a flowchart showing an example of the first data processing procedure in the printer according to the invention;

FIG. 7 is a flowchart showing an example of a second data processing procedure in the printer according to the invention;

FIG. 8 is a flowchart showing an example of a third data processing procedure in the printer according to the invention; and

FIG. 9 is a diagram for explaining a memory map in a memory medium for storing various data processing programs which can be read out by a print system to which the printer according to the invention can be applied.

### DETAILED DESCRIPTION OF THE PREFERRED EMBODIMENTS

Embodiments of the invention will be described hereinbelow.

(First embodiment)

First, typical printers among printers in which standardization of various wireless communication systems which will be explained in the embodiment is progressed will be described.

An example of the standardization of a system for transmitting and receiving packetized data by using a carrier wave in a wireless manner will now be mentioned. In the IEEE Standardization Committee, a physical layer and a media access control layer (hereinafter, abbreviated to an MAC layer) of a wireless LAN have been standardized as a name “IEEE std 802. 11” and, further, the higher speed physical layer and MAC layer have been standardized as names “IEEE std 802. 11b” and “IEEE std 802. 11a”. In “IEEE std 802. 11”, the use of not only the carrier wave but also infrared rays is included. On the other hand, in “IEEE std 802. 11b” and “IEEE std 802. 11a”, only the carrier waves are used at present.

A frequency band of the carrier waves which are used in “IEEE std 802. 11” and “IEEE std 802. 11b” is equal to a band of 2.4 GHz (gigahertz) in which the user does not need to obtain a license.

In “IEEE std 802. 11”, a communication speed lies within a range from 1 Mbits/sec (megabits per second) to 2 Mbits/sec. In “IEEE std 802. 11b”, besides the above speed, communication speeds of 5.5 Mbits/sec and 11 Mbits/sec are added. In “IEEE std 802. 11a”, although a frequency band of the carrier wave which is used differs, a communication speed within a range from 6 Mbits/sec to 54 Mbits/sec has been specified. As a communication distance of the product which conforms to “IEEE std 802. 11b”, about 30m is possible in case of 11 Mbps. If the communication speed is reduced, communication of a longer distance is possible.

As a wireless communication system using the carrier wave, both of a direct spread system (DS system) and a frequency hopping system (FH system) are used in “IEEE std 802. 11”, and the DS system is used in “IEEE std 802. 11b”.

In “IEEE std 802. 11a”, a band of 5 GHz is used and a system of OFDM (Orthogonal Frequency Division Multiplexing) is used.

In IEEE, the realization of a high speed at a 2.4 GHz band has been examined in a work sectional meeting of “802. 11g” and the improvement of the functions and performance has been examined in another work sectional meeting.

There is “Bluetooth” (registered trademark) as another system which has recently been highlighted as a wireless communication system using the 2.4 GHz band. According to the present standard in “Bluetooth” (registered trademark), the communication speed is equal to 1 Mbps and the communication distance is equal to about 10m, so that the communication speed is lower and the communication distance is shorter than those in “IEEE std 802. 11b”. “Bluetooth” has been standardized by presuming handy application such as communication between a cellularphone and a headset, communication between a portable personal computer and a cellularphone, or the like.

Although “IEEE std 802. 11b” uses the DS system, “Bluetooth” (registered trademark) uses the FH system. In “Bluetooth”, besides the standard of the physical layer and link layer, a specification called a profile for specifying an implementing method of a protocol stack every application has been determined by presuming each application. As those profiles, various specifications such as headset profile, dial-up networking profile, file transfer profile, printing profile, and the like as well as the profiles which are at present being developed are being specified. They are determined every application such as application for outputting audio data to a headset, application for performing the dial-up operation, application for performing the file transfer, application for printing, or the like. Both apparatuses for making communication have to conform to the profile corresponding to the application. For example, to print and output data to the printer from a portable terminal apparatus or the like by using “Bluetooth”, the portable terminal apparatus or the like and the printer have to implement the physical layer and upper layer according to the standard of “Bluetooth” and conform to the printing profile.

Explanation will be made hereinbelow with reference to the drawings.

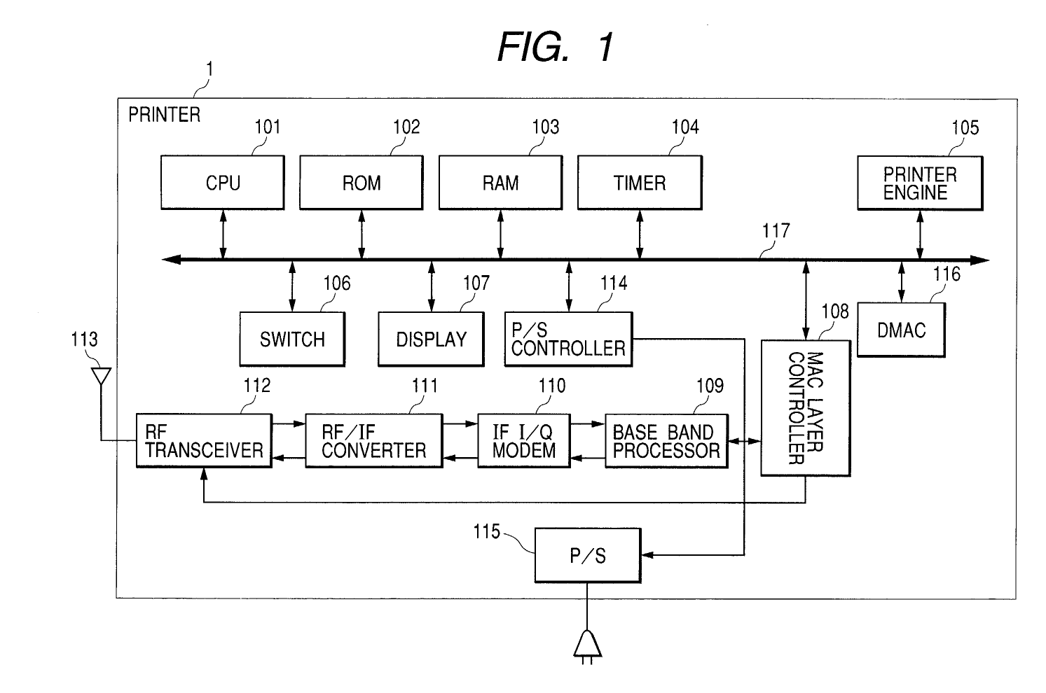

FIG. 1 is a block diagram for explaining a control construction of a printer showing the first embodiment of the invention.

In the diagram, reference numeral 1 denotes a printer (printing apparatus) and 101 indicates a central processing unit (CPU) for controlling each unit such as printer engine 105 of the printer 1, MAC layer controller 108, or the like. The CPU 101 also has a function for performing a data process such that print data received from an external information terminal apparatus is converted into data in a format such that the printer engine 105 can print and output it onto a medium, or the like. Reference numeral 102 denotes an ROM (Read Only Memory) as a memory medium in which a program command code and the like which are read out by the CPU 101 have been stored; 103 an RAM (Random Access Memory) for allowing the CPU 101 to write or read out data as necessary; 104 a timer which starts the time counting operation by a control of the CPU 101 and notifies the CPU 101 of a set elapsed time; and 105 the printer engine which differs depending on the kind of printer. For example, if the printer 1 is an ink jet printer, a paper feeding mechanism, a print head, an ink cartridge, a paper delivering mechanism, and the like are included in the printer engine 105. The printer engine 105 also has various means for detecting errors of no-paper detecting means, paper jam detecting means, detecting means for detecting the presence or absence of remaining ink, and the like, and means for detecting the absence of consumables.

Reference numeral 106 denotes a switch such as a power switch or the like. When the switch is depressed, the CPU 101 is notified of information indicative of the depression of the switch, or the CPU 101 periodically monitors a state of the switch. Reference numeral 107 denotes a display using a liquid crystal touch panel display or the like including various operating functions of an LED (Light Emitting Diode), an LCD, a liquid crystal panel, and a printer for displaying by the control of the CPU 101.

Reference numeral 108 denotes the MAC layer (media access control layer) controller which operates in accordance with “IEEE std 802. 11b”. The MAC layer controller 108 is a portion for performing an assembly/decomposition of a frame which is transmitted or received in a wireless manner, creating a control frame, controlling an obtainment of a wireless communication channel, controlling a communication speed, and the like. Reference numeral 109 denotes a base band processor for performing modulation/demodulation, encoding/decoding, an analog/digital conversion, and the like of the frame.

Reference numeral 110 denotes an I/Q (In phase/Quadrature) modem of an IF (Intermediate Frequency) for performing filtering of an IF signal for transmission and a reception IF signal, a 4-phase modulation/demodulation, and the like. Reference numeral 111 denotes an RF/IF converter which inputs the IF signal outputted by the IF I/Q modem 110, converts it into an RF (Radio Frequency) signal, outputs it to an RF transceiver 112, and allows it to be outputted from an antenna 113 via the RF transceiver 112. On the contrary, when the RF signal received by the antenna 113 is inputted to the RF/IF converter 111 via the RF transceiver 112, the RF/IF converter 111 converts it into the IF signal and outputs it to the IF I/Q modem 110. The RF transceiver 112 amplifies the RF signal and performs a switching of the transmission/reception or the like by an instruction of the MAC layer controller 108. The antenna 113 generates an output signal of the RF transceiver 112 as a carrier wave or converts the received carrier wave (detection and reception of the carrier wave) into an electric signal as an RF signal. The component elements in a range from the base band processor 109 to the antenna 113 are used for forming the physical layer according to “IEEE std 802. 11b”. The component elements in a range from the MAC layer controller 108 to the antenna 113 described here operate as a communication processor, so that the data including the print data and various commands are transmitted and received to/from the outside.

Reference numeral 114 denotes a power source controller (P/S controller) which operates by the control of the CPU 101 and controls an output of a power source (P/S) 115 on the basis of procedures shown in flowcharts, which will be explained hereinlater. In case of Japan, the P/S 115 converts, for example, 100 ACV into a desired DC voltage and supplies it to each unit. An output of the P/S 115 is controlled by the foregoing P/S controller 114.

Reference numeral 116 denotes a DMAC (Direct Memory Access Controller) which is used for transferring the print data stored by decomposing the received frame or the like to the RAM 103 from a memory (not shown) in the MAC layer controller 108, or the like and has functions of the data processor and the communication processor, respectively.

Reference numeral 117 denotes an internal bus for connecting the CPU 101 to the ROM 102, RAM 103, timer 104, printer engine 105, switch 106, display 107, MAC layer controller 108, P/S controller 114, and DMAC 116.

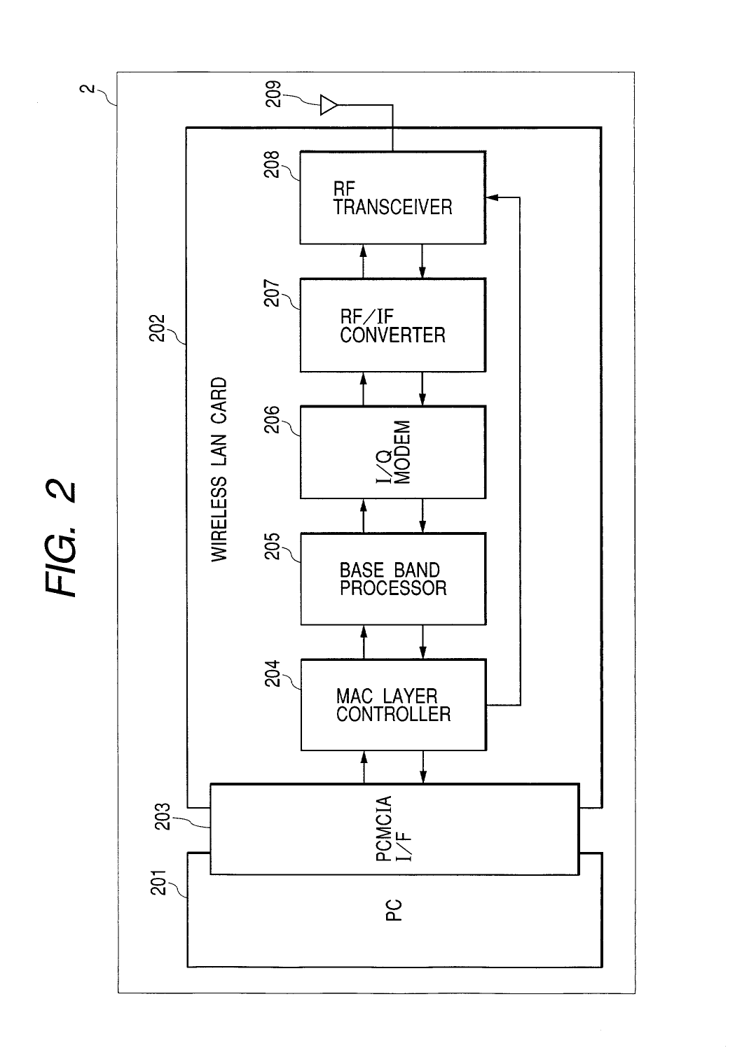

FIG. 2 is a block diagram showing an example of an information terminal apparatus according to the embodiment of the invention.

In the diagram, reference numeral 2 denotes a personal computer system serving as an information terminal apparatus, and this personal computer system has wireless communicating means; 201 a personal computer of, for example, a notebook-type; and 202 a wireless LAN card as wireless communicating means. The wireless LAN card 202 conforms to, for example, “IEEE std 802. 11b”.

Reference numeral 203 denotes a PCMCIA interface for connecting the personal computer 201 to the wireless LAN card 202.

Reference numeral 204 denotes an MAC layer controller which operates in accordance with “IEEE std 802. 11b”. The MAC layer controller 204 is a portion for performing an assembly/decomposition of the frame, creating a control frame, controlling an obtainment of a wireless communication channel, controlling a communication speed, and the like. Reference numeral 205 denotes a base band processor for performing modulation/demodulation, encoding/decoding, an analog/digital conversion, and the like of the frame. Reference numeral 206 denotes an IF (Intermediate Frequency) signal transceiver for performing filtering of the IF signal for transmission and the reception IF signal, a 4-phase modulation/demodulation, and the like.

Reference numeral 207 denotes an RF/IF converter which inputs the IF signal outputted by the IF signal transceiver 206, converts it into the RF (Radio Frequency) signal, outputs it to an RF transceiver 208, and allows it to be outputted from an antenna 209 via the RF transceiver 208. On the contrary, when the RF signal received by the antenna 209 is inputted to the RF/IF converter 207 via the RF transceiver 208, the RF/IF converter 207 converts it into the IF signal and outputs it to the base band processor 205.

The RF transceiver 208 amplifies the RF signal and performs a switching of the transmission/reception or the like by an instruction of the MAC layer controller 204. The antenna 209 generates an output signal of the RF transceiver as a carrier wave or converts the received carrier wave into an electric signal as an RF signal.

It is assumed that the printer also has a central processing unit (CPU), input/output means such as non-volatile or volatile memory means, and the like which a general computer has.

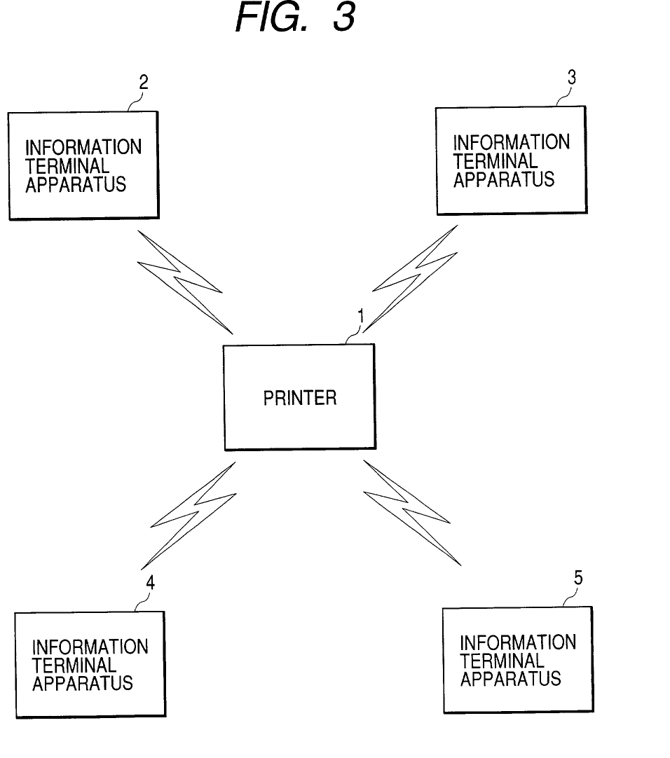

FIG. 3 is a diagram showing a print processing system to which the printer according to the invention can be applied. For example, this system corresponds to an example of a wireless communication print processing system comprising the printer 1 shown in FIG. 1, the information terminal apparatus 2 shown in FIG. 2, and other information terminal apparatuses 3 to 5 each having a construction similar to that in FIG. 2. It is assumed that print data can be printed and outputted from each of the information terminal apparatuses 3 to 5 to the printer 1.

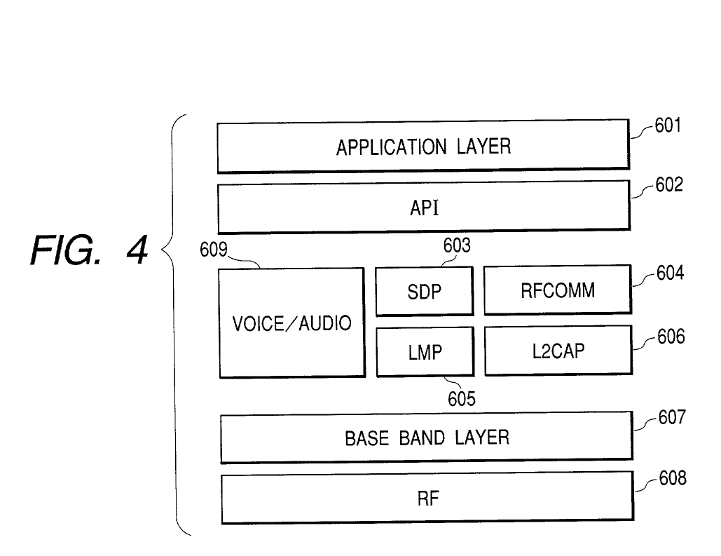

FIG. 4 is a diagram for explaining an example of a layer structure of data processes which are applied to the printer according to the invention, and a layer construction of “Bluetooth” will now be explained as an example.

In FIG. 4, reference numeral 601 denotes an application layer which differs depending on the apparatus or function, and 602 indicates what is called API (Application Interface) corresponding to a portion for interlinking the application layer 601 and an RFCOMM 604 and the like.

A protocol stack which is implemented differs depending on the profile. For example, a protocol stack which is called a serial port emulation in case of a serial port profile, a protocol stack which is called a headset control in case of the headset profile, and a protocol stack which is called a dialing and control in case of the dial-up connecting profile or facsimile profile are necessary in this portion.

Reference numeral 603 denotes which is called SDP (Service Discovery Protocol) as a protocol which is used by the application layer 601 in order to know service information of an apparatus on the communication partner side. Reference numeral 604 denotes which is called RFCOMM as a layer which is used for logically connecting application layers of two apparatuses.

Reference numeral 605 denotes which is called an LMP (Link Management Protocol) for making a control and a management of a communication link which is defined by a base band layer 607. Reference numeral 606 denotes which is called L2CAP (Logical Link Control & Adaptation Protocol) for playing roles such that a logical channel is set, a packet is segmented and reconstructed, the data is distributed or multiplexed in accordance with a kind of protocol, and the like.

Reference numeral 607 denotes which is called a base band layer as a portion for providing a communication link of a communication system called SCO (Synchronous Connection Oriented) for communicating an audio sound synchronously with clocks of a predetermined period or a communication system called ACL (Asynchronous Connectionless) for asynchronously communicating non-audio data, assembling or decomposing an SCO packet or an ACL packet, and executing an error correction or the like. An RF 608 is a portion for transmitting and receiving a radio wave by a spread spectrum system of the frequency hopping type by using a frequency in the 2.4-GHz band. A voice/audio 609 is a portion for providing a mechanism for transmitting and receiving a voice signal or an audio signal in a real-time manner. Although the functions described with reference to FIG. 4 are realized by, for example, storing program codes for realizing the functions into the ROM 102 and allowing them to be executed by the CPU 101. As another embodiment, for example, the application layer 601, API 602, SDP 603, and RFCOMM 604 are realized by a method whereby the CPU 101 reads out and executes the program codes stored in the ROM 102 (non-volatile memory means) shown in FIG. 1 (in cooperation with each hardware). The LMP 605 and L2CAP 606 in FIG. 4 are portions corresponding to the MAC layer controller 108 shown in FIG. 1. The base band layer 607 corresponds to the base band processor 109 in FIG. 1. The RF 608 corresponds to the IF I/Q MODEM 110, RF/IF converter 111, RF transceiver 112, and antenna 113 in FIG. 1. Although a portion corresponding to the voice/audio 609 is not shown in FIG. 1, it is presumed that it is properly implemented into the printer 1.

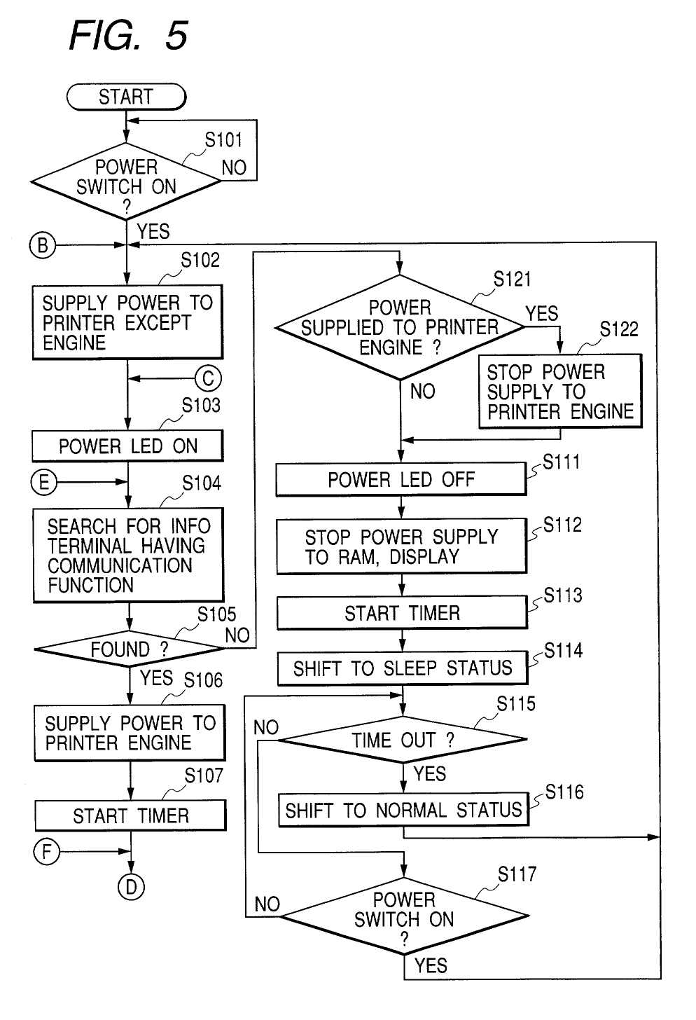

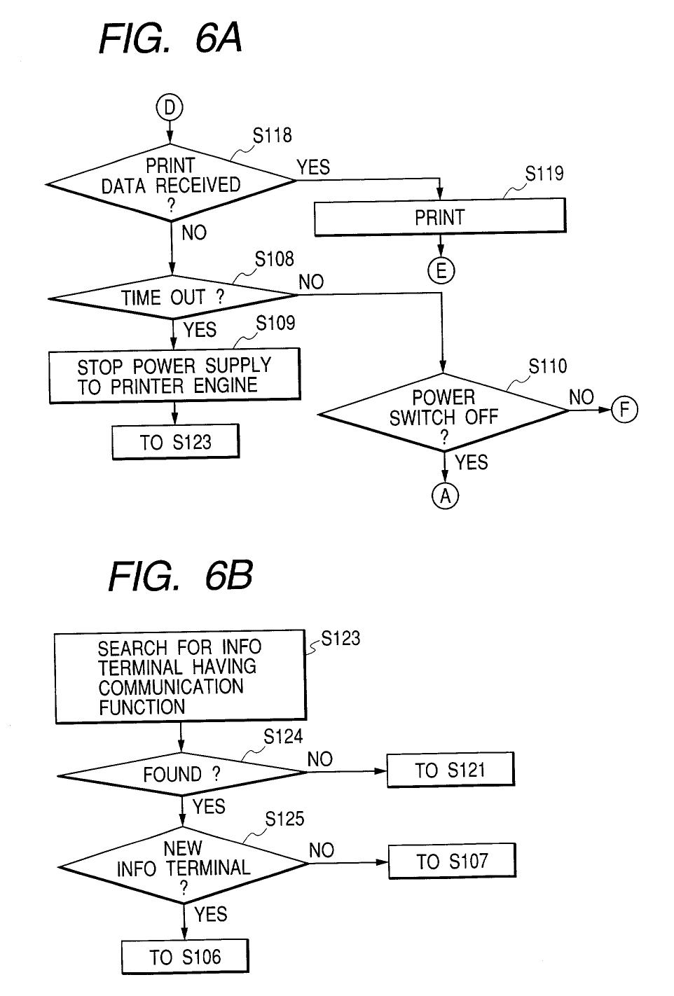

FIGS. 5, 6A, and 6B are flowcharts showing an example of a first data processing procedure in the print control apparatus according to the invention and correspond to an example of a first power control procedure by the P/S controller 114 shown in FIG. 1. S101 to S122 indicate processing steps and they are realized by a method whereby the CPU 101 executes processes according to the program codes stored in the non-volatile memory means (ROM 102).

Prior to step 101, an AC cable of the printer 1 is connected to an AC outlet and, although a power LED provided in the display of the printer 1 is not ON, a power source is supplied from the P/S 115 to the CPU 101, ROM 102, and switch 106, respectively. It is assumed that the CPU 101 is in a status where it can detect the switching operation of the switch 106 and a status where it can execute the program in the case where the switching operation is detected.

In the above status, when the CPU 101 detects the depression of the power switch in the switch 106 (S101), the CPU regards it as an operation for turning on a power source and controls the P/S controller 114, thereby allowing a necessary power source to be supplied from the P/S 115 to each portion other than the print processor such as a printer engine 105 and the like regarding the printout process (S102). That is, in step S102, the CPU 101 controls so as to supply the power source from the P/S at least to the portions regarding the data communicating process such as RF transceiver 112, RF/IF converter 111, IF I/Q modem 110, base band processor 109, the MAC layer controller 108, and CPU 101 in FIG. 1, so that the printer 1 enters a status where the data can be transmitted/received to/from the external apparatus.

The process in step S102 is not limited to the form of controlling so that the power source is not supplied only to the printer engine, but power saving processes with a plurality of steps in the following forms are also presumed. That is, there are presumed a form of controlling so that the power source is not supplied to the data processor (corresponding to the CPU 101, RAM 103, etc.) having the function for converting the print data from the external information terminal apparatus into the data in a format which can be processed by the printer engine 105, a form of controlling so that the power source is not supplied to the display, and the like. By providing the power saving processes with a plurality of steps as mentioned above, more flexible and finer energy saving can be realized. At this time, with respect to the portions to which the power source is not supplied in step S103, since it is easily presumed that they enter a form such that the power source is supplied to them in step S106, which will be explained hereinlater, in correspondence to such a non-power supply state, its detailed explanation is omitted.

In step S103, the power LED in the display 107 is turned on. Further, as shown in FIG. 3, the CPU 101 broadcast transmits a packet signal in a wireless manner to all terminal apparatuses in a range where a radio wave from the printer 1 can reach via the MAC layer controller 108, base band processor 109, IF I/Q modem 110, RF/IF converter 111, RF transceiver 112, and antenna 113 (S104). That is, the packet signal is a signal to search for the information terminal apparatuses having a function for allowing the printer 1 to print and output the print data.

Functions which are features of the invention and used for analyzing the profile that is sent from the terminal apparatus as a response will now be explained. Specifically speaking, a search (inquiry) for the information terminal apparatuses having functions (i) to (iii) for allowing the printer 1 to print and output the print data will be explained in detail.

Function (i)

For example, if the wireless communication function which the printer 1 has is “Bluetooth” (registered trademark), the following sequence is considered. That is, the SDP (Service Discovery Protocol 603: refer to FIG. 4) is used in accordance with the service discovery application profile, and all of the terminal apparatuses 2 to 5 in the range where the radio wave (detection and reception of the carrier wave) from the printer 1 can reach are inquired about the profiles which those terminal apparatuses 2 to 5 have, respectively. In response to such an inquiry, if there is not a response showing that the terminal apparatus has at least the printing profile, it is determined that this apparatus does not have the function for allowing the printer 1 to print and output the print data. As mentioned above, the printer in the embodiment can execute a control for inquiring the information terminal apparatuses existing in the range where communication can be made together with the function kind in accordance with the wireless data transmission system by the communication processor. The absence of the response showing that the apparatus has the printing profile denotes that the response itself to the inquiry is not made and that another profile information (for example, profile information of a scanner, a facsimile, or a digital camera) different from the printing profile is included in the response to the inquiry.

The foregoing printing profile indicates information showing that the apparatus has the function for outputting the print data for allowing the printer to execute the printing operation. It is assumed that a case where the printing profile has been standardized as a specification according to the printer or a case where the printing profile has a specification which the designer has independently developed in order to notify such information is also included. As a specification which has independently been developed, for example, a mechanism for transmission and reception of data for confirming whether the information terminal apparatus has a printer driver corresponding to the printer (whether the printer driver has been installed) or not in the case where a printer driver has a form depending on the printer, or the like is presumed.

If the printing profile is included in the response to the inquiry, it is determined that the apparatus has the function for allowing the printer 1 to print and output the print data.

Further, if the printer 1 is a printer which needs dedicated driver software in an apparatus on the communication partner side, whether the driver software has been installed or not is inquired. If it has been installed, it is determined that the apparatus has the function for allowing the printer 1 to print and output the print data. If it is not installed, it is determined that the apparatus does not have the function for allowing the printer 1 to print and output the print data. As mentioned above, the printer in the embodiment can analyze the kind information of the printer driver included in the printing profile.

Function (ii)

In the case where the printer 1 has a communication system according to “IEEE 802. 11” in which the layers below the MAC layer of the conventional wired LAN (Local Area Network) have been replaced with the layers for wireless communication, since the concept of the profile as mentioned above does not exist, if the printer 1 is a printer which needs dedicated driver software in an apparatus on the communication partner, whether the driver software has been installed or not is inquired. If it has been installed, it is determined that the apparatus has the function for allowing the printer 1 to print and output the print data. If it is not installed, it is determined that the apparatus does not have the function for allowing the printer 1 to print and output the print data.

Although the two kinds of communication systems have been described above, the invention is not limited to them but can be also naturally applied to other communication systems.

Function (iii)

If the printer 1 has a function for receiving data such as image file data or the like, converting the received file into print data, and printing and outputting the converted data, it is presumed that the apparatus itself (printer 1) searches whether apparatuses which can transmit data in a file format which can be converted into the print data to the self apparatus (printer 1) exist or not. For example, a JPEG image file, a bit map file, and the like which are generally used in a digital still camera can be mentioned as a file format which can be converted into the print data.

In such a case, the printer 1 executes inquiry by using a predetermined communication system as to whether there are any peripheral apparatuses which store date of a file format that can be printed without any process of a host computer or the like in the apparatus itself (printer 1) and which can transmit the data to the printer, so as to determine whether there exists an apparatus having the function for allowing the printer 1 to print and output the print data in response to the inquiry.

Or, it is presumed to search for the apparatuses having the file format such as JPEG image file, bit map file, etc. in which the printer can convert it into the print data and directly print and output it. As such apparatuses, besides the digital still camera, for example, a digital video cam recorder, a scanner, a set-top box, and the like can be mentioned.

In step S105 shown in FIG. 5, when a packet which responds to the packet to be searched is received, for example, from the information terminal apparatus 2 via the antenna 113, RF transceiver 112, RF/IF converter 111, IF I/Q modem 110, base band processor 109, and MAC layer controller 108 (in case of YES in step S105), the CPU 101 supplies an instruction to the P/S controller 114 and controls so as to supply a power source from the P/S 115 also to the portions regarding the print-out process including the printer engine 105 and the like (S106). Thus, the printer 1 enters a print standby mode. After that, if the print data is received as a packet from the information terminal apparatus 2, the printer can immediately execute a print-out process.

Further, the CPU 101 sets a time which has previously been stored in the ROM 102 into the timer 104 and allows the timer to start the counting operation (S107). Whether the elapse of the set time has been notified by the timer 104 or not, that is, whether the time-out has occurred or not is discriminated (S108). If YES in step S108, the power supply to the printer engine (print processor) is stopped (S109). The processing routine advances to step S123.

In a process between steps S107 and S108, whether the print data has been received from the external information terminal apparatus or not is discriminated by the CPU 101 (S118). If it is determined that the print data has been received (YES in step S118), the received print data is converted by the CPU 101 into data in a data format which can be outputted by the printer engine 105 and, thereafter, it is printed onto a medium by the printer engine 105 (S119). After that, step S104 follows. In the process in step S119, a process for discriminating whether the power source has been supplied to the printer engine (print processor) or not is actually executed. If it is determined in step S119 that the power source necessary for executing the print-out process in step S119 is not supplied, the power supply to a proper necessary portion (for example, printer engine) is executed.

If it is determined that the print data is not received by the CPU 101, the processing routine advances to the process in step S108 described above. Whether the time-out of the timer has occurred or not is discriminated in step S108. The processing routine advances to the process in step S109 or S110 in accordance with a result of the discrimination in step S108.

As a modification, if the apparatus is constructed in a manner such that in case of shifting to step S105 after completion of the process in step S109, even if the information terminal apparatus having a function (communication function of the print data corresponding to the printer) which enables the printer to execute the printing process was confirmed, by stopping the power supply to the print processor including the printer engine 105 in step S106, the larger power saving can be realized. A processing flow in such a construction is shown in FIG. 6B. After completion of the process in step S109 in FIG. 6A, the information terminal apparatus having the function which enables the printer to execute the printing process is searched in step S123. Whether the existence of such an apparatus has been confirmed or not is discriminated (S124). If it has been confirmed, whether the existence of other information terminal apparatus different from the previous information terminal apparatus has been confirmed or not is discriminated by the CPU 101 (S125). If only the same information terminal apparatus as the previous apparatus has been confirmed (NO in S125), the power source is not supplied to the print processor including the printer engine 105. If at least information terminal apparatus different from the previous apparatus has been confirmed (YES in S125), the P/S controller 114 is instructed to supply the power source to the print processor including the printer engine 105 in step S106. By this construction, the larger power saving can be realized and the more efficient power saving process can be realized.

Returning to FIG. 5, in step S105, if a response packet signal to the packet signal for searching for the information terminal apparatus having the function for allowing the printer 1 to print and output the print data is not received (NO in step S105), first, a discrimination about whether the power supply of the print processor including the printer engine 105 is in the standby mode or not is executed by the CPU 101 (S121). This process corresponds to the process of shifting from step S119 to step S104 and is a discriminating process which is executed by the CPU 101 in order to realize the power saving in the case where the information terminal apparatus having the function for allowing the printer to execute the printing operation is not confirmed in a status where the power supply to the print processor including the printer engine 105 is held in the standby mode.

If YES in step S121, the CPU instructs the P/S controller 114 to stop a part or all of the power supply to the print processor including the printer engine 105 (S122). After a power control process was executed, the processing routine advances to a process in step S111. If NO in step S121, the CPU, 101 turns off the power LED in the display 107 (S111) and instructs the P/S controller 114 to stop a part or all of the power supply from the P/S 115 to the RAM 103 and display 107 (S112).

Further, the CPU 101 allows the timer 104 to start the counting operation (S113) in a manner similar to step S107 (S113) and the CPU 101 itself is shifted to a sleep status (S114). In the embodiment, the sleep status is a status where, for example, a clock is switched to a clock of a frequency lower than that in the normal operating status and, when an interruption signal or the like is inputted, the apparatus is recovered to the normal operating status. It is assumed that in the sleep status, an electric power consumption is smaller than that in the normal operating status. It is also assumed that if the CPU in the sleep status executes the timer process in step S114, a control program using counter parameters according to a low frequency has been stored in an apparatus which mainly executes the process in a form such that it can be executed. As mentioned above, as a result of the inquiry in step S104, if the existence of the information terminal apparatus of the function kind having the function for transmitting the data for allowing the printing process to be executed is not confirmed, the power supply mode from the P/S to the print processor can be shifted to a low electric power consumption mode. Power control of efficiency better than that in the conventional apparatus such that if a state where the apparatus does not receive the print data for a predetermined time is confirmed is realized, the operating mode is shifted to the power saving mode.

In step S115, whether the time at which the timer 104 started the counting operation has elapsed, that is, the time-out has occurred or not is discriminated. If an interruption signal is outputted to the CPU 101 due to the occurrence of the time-out (YES in step S115), the CPU 101 is recovered to the normal operating status (S116). The processing routine is returned to step S102 and the processes in step S102 and subsequent steps are executed again, thereby searching for the information terminal apparatus having the function for allowing the printer 1 to print and output the print data again after the elapse of a predetermined time. When the processing routine advances from step S116 to step S102, it is presumed in step S102 that the power supply corresponding to the process for searching for the information terminal apparatus having the communication function to the printer in step S104 is executed.

The invention also presumes a case where the searching process which is executed by the CPU 101 in order to discriminate the presence or absence of the information terminal apparatus having the function for allowing the printer to execute the printing operation is executed at a predetermined period (the predetermined period is measured by the timer 104) separately from the processes in FIG. 5, the search result of the searching process is held as electronic data such as a flag into the RAM 103 or the like, and the electronic data such as a flag is discriminated in step S104 in FIG. 5.

Further, the invention also presumes a case where the predetermined period which is set in the case where the check result in step S105 is NO and that in case of YES are set to different periods. For example, if the period in case of NO in step S105 is set to be shorter than that in case of YES, an effect such that even if an information terminal apparatus which intends to execute the printing operation has newly entered the range where wireless communication can be made, it is possible to promptly cope with such a case can be also obtained.

Before the timer 104 generates the interruption signal in step S115, that is, if NO in step S115 and if the depression of a power switch in the switch 106 is recognized in step S117 by the interruption signal or the like (YES in step S117), the CPU 101 is recovered to the normal operating status. The processing routine is returned to step S102.

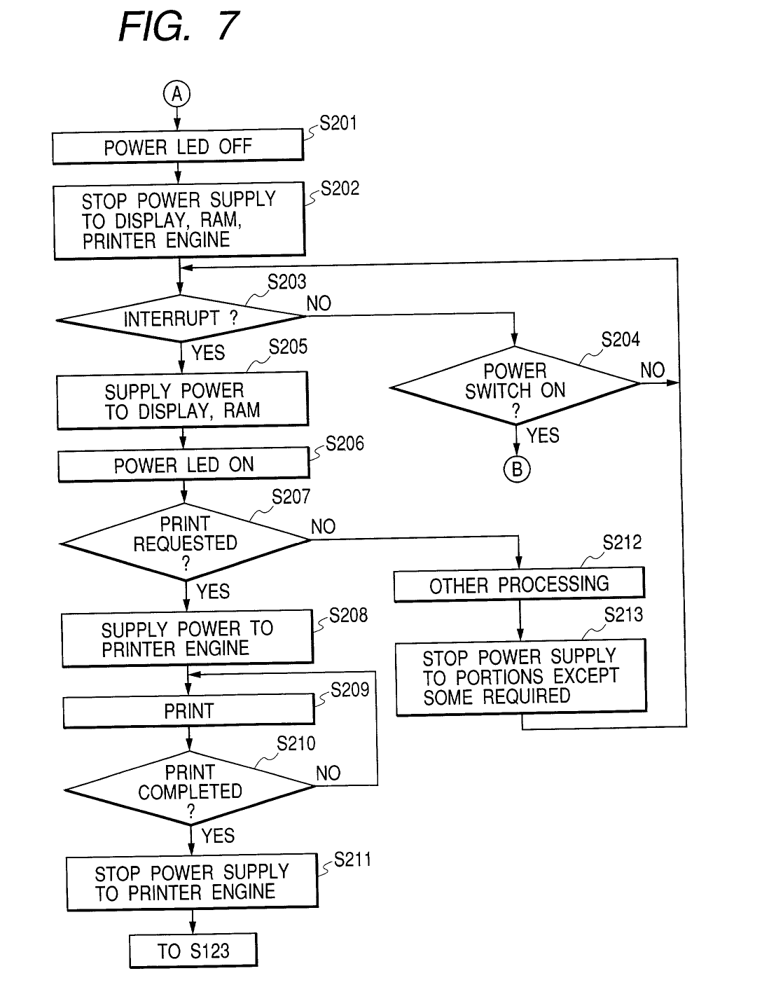

It is also possible to construct the apparatus in a manner such that before the elapse of the set time by the timer 104 is notified in step S108 (NO in step S108), if the depression of a power switch in the switch 106 is detected, a series of processes can be finished. However, processes can be also executed as shown in a flowchart in FIG. 7. The flowchart in FIG. 7 will be explained in the second embodiment.

By executing the power control shown in the first embodiment as mentioned above, the information terminal apparatus having the function for allowing the printer 1 to print and output in a wireless manner can be searched. If there is a response from the relevant information terminal apparatus, the printer 1 is shifted to a status where it can execute the print-out process and enters a standby mode, and when the print data is received, the print output can be immediately started.

There is an effect such that if there is no response, it is determined that the information terminal apparatus having the function for allowing the printer 1 to print and output in a wireless manner does not exist in the range where the communication can be made from the printer 1 in a wireless manner, and the apparatus can be shifted to a status of the necessary least electric power consumption.

Since the foregoing search can be performed every elapse of the predetermined time by using the timer, there is an effect such that in the case where a portable information terminal apparatus peculiar to the wireless communication has newly entered the range where wireless communication can be made from the printer 1, such an apparatus can be found, or contrarily, in the case where the information terminal apparatus existing in the range where wireless communication can be made from the printer 1 is moved and does not exist, the absence of such an apparatus can be confirmed.

In other words, if the apparatuses which can communicate with the printer 1 because the printer 1 exists in the range where wireless communication can be made and the power source is ON or the like are only a cellular phone, a headset, a remote controller, and the like which do not output the print data to the printer 1, or if such apparatuses do not have printer drivers corresponding to the printer 1, the printer 1 can be shifted to the status of the necessary least electric power consumption. Such apparatuses are again searched after the elapse of the predetermined time notified by the timer, so that if a personal computer or the like having the function for allowing the printer 1 to print and output the print data has entered the range where wireless communication can be made or a power source of the personal computer or the like which has existed before and whose power source has been turned off is turned on and the personal computer or the like is started, the printer 1 can be shifted to a status where the print-out process can be executed,. and can enter a standby mode.

(Second embodiment)

FIG. 7 is a flowchart showing an example of a second data processing procedure in the printer according to the invention and corresponds to an example of the second power control procedure by the P/S controller 114 shown in FIG. 1. S201 to S214 show processing steps. Also in the second embodiment, the printer 1 comprises a block having the various means as shown in FIG. 1 and it is assumed that as an example of the information terminal apparatuses 2 to 5, there is a personal computer as shown in FIG. 2 and the printer 1 and the information terminal apparatuses 2 to 5 exist in the wireless communication system as shown in FIG. 3. The processing steps shown in FIG. 7 are realized by a method whereby the CPU 101 executes the processes corresponding to the program codes stored in the non-volatile memory means (ROM 102).

In step S110 shown in FIG. 6A, if the CPU 101 recognizes the depression of the power switch in the switch 106 (YES in step S110), the CPU 101 regards it as an operation to turn off the power source, turns off the power LED in the display 107 (S201), and instructs the P/S controller 114 to stop the power supply from the P/S 115 to the display 107, RAM 103, and printer engine 105 (S202). Further, the CPU 101 shifts itself to the foregoing sleep status. Thus, the printer 1 is shifted to the low electric power consumption mode. When the process in step S202 is executed, the printer 1 is controlled by the CPU 101 and P/S controller 114 so that the power supply to the component elements in a range from the MAC layer controller 108 serving as a wireless communicator to the antenna 113 is maintained. The printer 1 is in a status where the radio signal can be transmitted and received to/from the external information terminal apparatus.

For example, when the MAC layer controller 108 receives the packet signal transmitted from the information terminal apparatus 2 in a wireless manner via the antenna 113, RF transceiver 112, RF/IF converter 111, IF I/Q modem 110, and base band processor 109, the MAC layer controller 108 generates the interruption signal to the CPU 101. Therefore, the CPU 101 discriminates whether the interruption signal has been received or not (S203). If YES in step S203, that is, if the interruption signal has been inputted, the CPU 101 is shifted from the sleep status to the normal operating status and, further, controls the P/S controller 114 so as to supply the power source from the P/S 115 to the display 107 and RAM 103 (S205), thereby turning on the power LED in the display 107 (S206).

In step S207, the CPU 101 further discriminates whether the packet to request the print-out has been received from the information terminal apparatus 2 or not. If it is determined that such a packet has been received or if the packet received in step S203 is a packet indicative of the request for the print-out, the CPU 101 also controls the P/S controller 114 so as to supply the power source from the P/S 115 to the print processor including the printer engine 105 of the printer 1 (S208) so that the print output can be performed and, subsequently, executes the print-out process in accordance with the packet including the print data which is received from the information terminal apparatus 2 (S209).

Whether the print-out process has been completed or not is discriminated in step S210. If the print-out process has been completed (YES in step S210), the CPU 101 controls the P/S controller 114 so as to stop the power supply from the P/S 115 to the printer engine 105 (S211). The processing routine is returned to step S123 shown in FIG. 6B.

Before the occurrence of the reception interruption in step S203, if the CPU 101 recognizes the depression of the power switch in the switch 106 (S204), the processing routine is returned to step S102 shown in FIG. 5.

Further, if it is determined that the packet received in step S203 is a packet of contents other than the packet indicative of the request for the print-out (NO in step S207), another necessary processing such that a response packet to the packet is transmitted or the like is executed (S212). The CPU turns off the power LED in the display 107 again and controls the P/S controller 114 so as to stop the power supply from the P/S 115 to the display 107 and RAM 103. The CPU 101 is again shifted to the sleep status or the like, thereby stopping the power supply to the portions other than the portions which need the power supply. Thus, the printer 1 is again shifted to the low electric power consumption mode.

According to the embodiment, even when the power switch is OFF, the wireless communicator of the printer 1 can operate and receive the packet from the information terminal apparatus 2. If there is a print-out request, it is possible to supply the power source to the printer engine 105 and immediately start the print-out process. Further, it is possible to search for the information terminal apparatus having the function for allowing the printer 1 to print and output the print data in a wireless manner every predetermined time after completion of the print-out process.

(Third embodiment)

It is also possible to construct the apparatus in a manner such that the printer processor including the printer engine and a paper conveying mechanism is provided with printer status detecting means (sensors) for detecting errors of the printer and a state of consumables; that is, the error about whether print paper has been set or not, whether the print paper has been jammed or not, and whether ink to be ejected onto the print paper for print-out or toner to be adhered onto the print paper remains or not, and the packet transmission to search for the information terminal apparatus having the function for allowing the printer 1 to print and output the print data in a wireless manner as mentioned in the first embodiment is executed in accordance with a detection result of each of the detecting means.

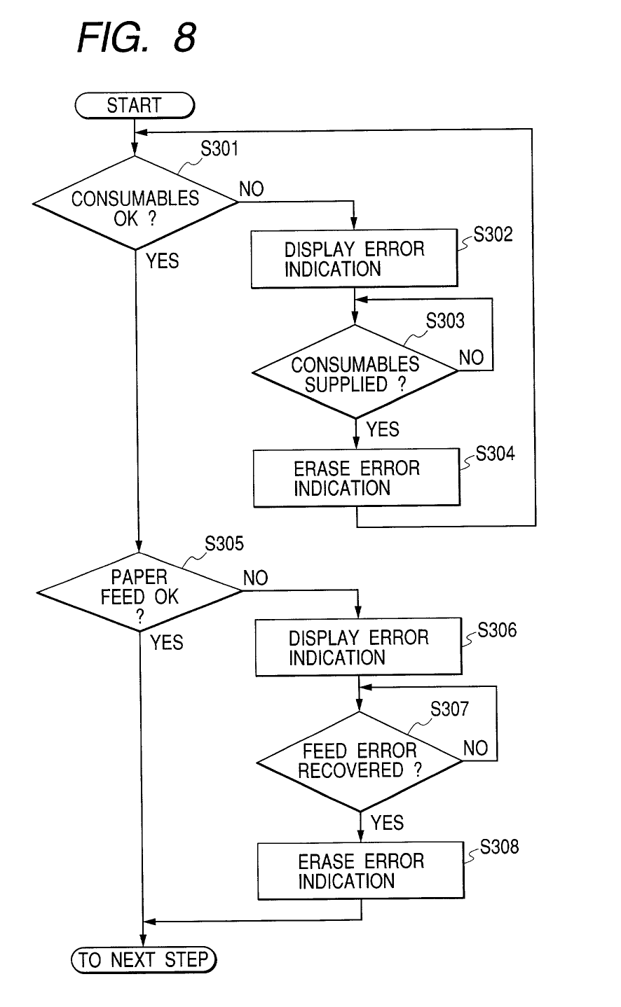

The above processing procedure will now be described with reference to a flowchart of FIG. 8. Processing steps shown in FIG. 8 are realized by a method whereby the CPU 101 reads out and executes the program codes stored in the ROM 102 (non-volatile memory means).

Explanation will now be made on the assumption that the processing procedure in FIG. 8 is inserted between steps S103 and S104 in FIG. 5. It is also assumed that a power source is also supplied to the error detecting means in step S103 in FIG. 5.

FIG. 8 is a flowchart showing an example of a third data processing procedure in the print control apparatus according to the invention. S301 to S308 denote processing steps, respectively.

If it is detected by the detecting means that there is no consumables such as ink, toner, or the like (NO in S301) or if a jam of the print paper is detected (NO in S305), an error is displayed on the display 107 (S302 and S306). If an ink tank or a toner cartridge has newly been exchanged and the presence of consumables has been detected (YES in S303) or the jammed print paper has been removed and the printer has been recovered from a paper feed error (S307), an error indication is erased (S304 and S308), and the processing routine advances to step S104 in FIG. 5. At this time, in steps S303 and S307, until it is decided that the consumables exist or until the CPU 101 determines that the jammed print paper has been removed and the printer has been recovered from the paper feed error, the process in step S104 is not executed.

The invention is not limited to the form in which the processing steps in the flowchart of FIG. 8 are inserted between steps S103 and S104 in FIG. 5 but it is also presumed that the processes in the flowchart of FIG. 7 are executed independent of the processes in the flowcharts of FIGS. 5 and 6. In such a case, for example, by executing the processes in a manner such that when the error or the absence of the consumables or the like is detected, even if it is decided that the information terminal apparatus exists in step S105 in the flowcharts of FIGS. 5 and 6, the processing routine advances to step S111, a power control such that a wasteful power source is not supplied from the printer (printing apparatus) to the print processor including the printer engine can be realized.

It is also possible to construct the printer in a manner such that if the error or the absence of the consumables or the like occurs in the printer (printing apparatus), the power source is supplied from the P/S to at least the communication processor, and although the print data is received, the power source is not supplied to the printer engine included in the print processor, the data processor, and the like, and if it is confirmed in the printer that the error or the absence of the consumables or the like has been eliminated, the print output to the paper medium is restarted. By using such a method, by transmitting the print data only once from the information terminal apparatus to the printer, the print can be certainly executed. An effect of avoiding troublesome operations such that the print data is repetitively transmitted and the like can be obtained.

As mentioned above, when a state where no print paper is set is detected, when the jam of the print paper is detected, when the absence of the remaining ink, toner, or developing agent is detected, or the like, step S104 shown in FIG. 5 is not executed. By this method, a situation such that wasteful communication is made in spite of the fact that even if the relevant information terminal apparatus exists, it is in a state where the print-out process cannot be executed can be suppressed, and it is possible to prevent the printer from being shifted to the electric power consumption mode.

Although the explanation has been made above with respect to the processes about the state where the print paper has been jammed with regard to the printer status or the state where there is no consumable, the invention is not limited to it, but every error such as abnormal increase in temperature of an engine fixing unit, deterioration of consumables in a photosensitive unit or the like, and the like, or the absence of the consumables is presumed. FIG. 7 can be applied to such errors or the absence of the consumables.

The detecting means for detecting whether the print paper has been set or not is not limited to the inside of the print engine but can be also provided for a print paper setting unit independent of the printer engine.

Although the construction such that the wireless communicator of the printer 1 is built in the apparatus has been shown here, it can be also attached to the printer 1 as a separate unit like a PC card.

On the contrary, in the information terminal apparatus 2, although the personal computer 201 and wireless communicator 202 have been connected by the PCMCIA interface 203, even if the wireless communicator 202 is built in the personal computer 201 or an interface other than the PCMCIA interface 203 is used, there is no problem.

As a printer 1, it is also possible to use another kind of printer such as ink jet type printer, thermal transfer printer, page printer, or the like. Further, the invention is not limited to the printer but can be also applied to another peripheral apparatus such as scanner (image reading apparatus) or a digital hybrid apparatus having the functions of a printer, a scanner, and the like.

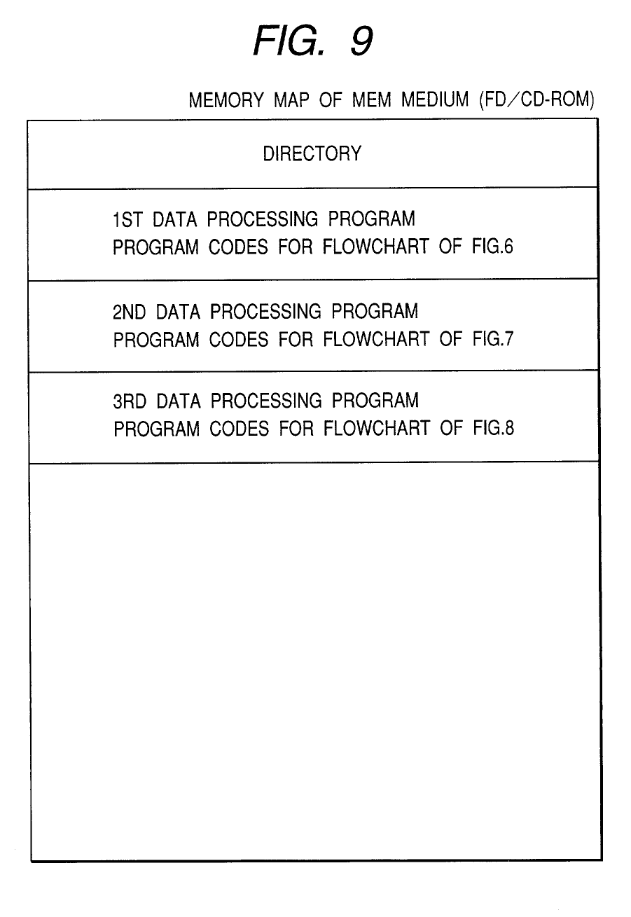

A construction of data processing programs which can be read out by a print system to which the print control apparatus according to the invention can be applied will be described hereinbelow with reference to a memory map shown in FIG. 9.

FIG. 9 is a diagram for explaining the memory map in a memory medium for storing the various data processing programs which can be read out by the print system to which the print control apparatus according to the invention can be applied.

Although not particularly shown in the diagram, information for managing the programs which are stored into the memory medium, for example, version information, implementors, and the like are also stored. There is also a case where information depending on the OS or the like on the program reading side, for example, icons to selectively display the programs and the like are stored.

Further, data depending on the various programs is also managed in the directory. There is also a case where a program to install the various programs into a computer and, if the installing program has been compressed, a program for decompressing it, and the like are stored.

The functions shown in FIGS. 5 to 8 in the embodiments can be also executed by a host computer in accordance with a program which is installed from the outside. In this case, the invention is also applied to the case where a group of information including the programs is supplied to an output apparatus from a memory medium such as CD-ROM, flash memory, FD, or the like or from an external memory medium via the network.

As mentioned above, naturally, the objects of the invention are also accomplished by a method whereby a memory medium in which program codes of software to realize the functions of the embodiments mentioned above have been recorded is supplied to a system or an apparatus, and a computer (or a CPU or an MPU) of the system or apparatus reads out and executes the program codes stored in the memory medium.

In this case, the program codes themselves read out from the memory medium also realize the novel functions of the invention, and the memory medium in which the program codes have been stored constructs the invention.

As a memory medium for supplying the program codes, for example, it is possible to use a floppy disk, a hard disk, an optical disk, a magnetooptic disk, a CD-ROM, a CD-R, a magnetic tape, a non-volatile memory card, an ROM, an EEPROM, a flash memory, or the like.

The invention incorporates not only a case where the functions of the embodiments mentioned above are realized by a method whereby a computer executes the read-out program codes but also a case where the OS (Operating System) or the like which is operating on the computer executes a part or all of the actual processes on the basis of instructions of the program codes, and the foregoing functions of the embodiments mentioned above are realized by those processes.

Further, the invention also incorporates a case where the program codes read out from the memory medium are written into a memory equipped for a function expanding board inserted into a computer or a function expanding unit connected to a computer and, thereafter, a CPU or the like provided for the function expanding board or function expanding unit executes a part or all of the actual processes on the basis of instructions of the program codes, and the foregoing functions of the embodiments mentioned above are realized by those processes.

Although the embodiments have been described with respect to the case where the communication processor for executing a predetermined radio data communicating process is built in the printer, the invention can be also applied to a printer in which the communication processor can be attached as a wireless interface card.

Although the embodiments have been described with respect to the form such that the printer and the information terminal apparatuses are connected as a wireless LAN as an example, in case of a form such that the printer and the information terminal apparatuses are connected as a wireless LAN via access points, as connecting forms of the wireless LAN, there are many forms such as (wireless→wireless), (wired→wireless), (wireless→wired), (wired→wireless→wired), and the like. The invention can be applied to any forms so long as the printer which can make the wireless communication is connected to the wireless side. Further, it is also possible to construct in a manner such that the printer also functions as an access point.

Further, the invention can be applied to a printer such that jobs from information terminal apparatuses are accumulated into a wired server apparatus and the jobs are received from the server apparatus by the wireless LAN via the access points.

According to the embodiments, whether the information terminal apparatuses having the function for allowing the printer to print out the print data exist in the range where the printer can communicate in a wireless manner or not can be discriminated. If the existence of the information terminal apparatuses is confirmed, by shifting the printer to the print standby mode, when the signal such as a packet or the like for requesting the print-out is received, the execution of the print-out process can be immediately started, and if the existence of the information terminal apparatuses is not confirmed, the printer is shifted to the low electric power consumption mode and there is an effect such that the wasteful electric power consumption can be avoided.

By executing the search for the information terminal apparatuses having the function for allowing the printer to print out the print data every elapse of a predetermined time, when the portable information terminal apparatus as a feature of the apparatus having the wireless communication function enter the range where the communication can be made from the printer, it can be found, and the printer can be shifted to the print standby mode in correspondence to it. Even if such an apparatus was moved from the range where the communication can be made and did not exist, the absence of such an apparatus can be confirmed. In such a case, the printer can be shifted to the low electric power consumption mode.

Even if the power switch is OFF, by enabling the wireless communicator of the printer to operate, the packet from the information terminal apparatus can be received. If there is a print-out request, by supplying the power source to the printer engine, the print-out process can be immediately started. After completion of the print-out process, the information terminal apparatus having the function for allowing the printer to print out the print data in a wireless manner can be searched every predetermined time.

Further, in the case where the print paper, ink, toner, or the like does not exist or in the case where the printer is in an abnormal status where the print paper is jammed, the search is not executed. By this method, there is an effect such that it is possible to prevent a situation that in spite of the fact that the printer cannot immediately execute the print-out process, wasteful communication is made or the printer is shifted to the print standby mode and consumes an electric power.

(Fourth embodiment)

Naturally, the printer of the invention is not limited to the construction shown in FIG. 1. For example, a trial of integrating the MAC layer controller 108 and base band processor 109 has also been made. A trial of constructing in a manner such that the IF I/Q modem 110 in FIG. 1 is replaced with the I/Q modem, the RF/IF converter 111 is deleted, and RF transceiver 112 and the I/Q modem are connected has also been made. However, the invention can be also applied to such constructions.

Further, although the embodiments have been described with respect to the cases where the invention is applied to “IEEE 802. 11b” and “Bluetooth” , the invention can be also applied to other various wireless communication such as systems which have been standardized or are being standardized by other IEEE like “IEEE 802. 11a”, “IEEE 802. 11g”, and the like, HomeRF (registered trademark), HiperLAN2 (registered trademark), which is being spread mainly in Europe and uses a band of 5 GHz, IrDA (registered trademark: Infrared Data Association) as a wireless communication system using infrared rays, and the like. In this case, it could easily have been made by those with ordinary skill in the art that the functions of the physical layer and MAC layer in each communication system can be applied to FIGS. 1 and 2.

As described above, according to the invention, an effect such that the electric power consumption can be remarkably reduced in correspondence to various ambient environments can be obtained.

What is claimed is:

1. A printer having a communication processor for making data communication with an information terminal apparatus by a predetermined wireless data transmission system and a print processor for printing and outputting print data received by said communication processor, comprising:
inquiry means for inquiring said information terminal apparatus existing in a range where the communication can be made by said wireless data transmission system by said communication processor together with a kind of function; and
power control means for controlling a power supply status of a power source which is supplied to said print processor in accordance with the function kind included in a response from said information terminal apparatus to the inquiry by said inquiry means.

2. A printer according to claim 1, wherein as a result of the inquiry by said inquiry means, if the existence of the information terminal apparatus of the function kind having a function to transmit data for allowing a printing process to be executed is not confirmed, said power control means shifts the power supply status from a power source to said print processor to a low electric power consumption mode.

3. A printer according to claim 1, further comprising monitoring means for controlling in a manner such that as a result of the inquiry by said inquiry means, if the existence of the information terminal apparatus of the kind having a function to transmit data for allowing a printing process to be executed is not confirmed, said power control means shifts a central processing unit provided for the printer itself to a sleep status, and further, even after said central processing unit is shifted to the sleep status, the inquiry by said inquiry means is executed.

4. A printer according to claim 1, further comprising analyzing means for analyzing a profile which is sent as a response in accordance with the inquiry by said inquiry means from the information terminal apparatus existing in a range where the communication can be made in accordance with said wireless data transmission system by said communication processor,
and wherein said power control means controls the power supply status of the power source which is supplied to said print processor in accordance with a result of the analysis by said analyzing means.

5. A printer according to claim 4, wherein at least a printing profile indicative of a print function is included in said profile.

6. A printer according to claim 5, wherein kind information of a printer driver stored in a form such that said information terminal apparatus can execute is included in said printing profile, and said power control means performs the power control in accordance with the kind information of said printer driver.

7. A printer according to claim 1, wherein said inquiry means has a function for recognizing the function kind and identification information of said information terminal apparatus and recognizes a change in existence of said information terminal apparatus in accordance with identification by said identification information, and said power control means shifts the power supply status from said power source to said print processor for printing said print data to a print standby mode in accordance with a result of said recognition.

8. A printer according to claim 1, wherein as a result of the inquiry by said inquiry means, if a change in existence of said information terminal apparatus having a function for transmitting data for allowing said printer to execute the printing is confirmed, said power control means shifts the power supply status from said power source to said print processor for printing said print data to a print standby mode.

9. A printer according to claim 1, wherein said print processor comprises: a data processor for processing the print data received by said communication processor; and a printer engine for printing and outputting the data processed by said data processor onto a recording medium.

10. A printer according to claim 9, wherein said printer engine includes a printer engine of a kind of an ink jet system or an electrophotographic system.

11. A power control method by a print control apparatus having a communication processor for making data communication with an information terminal apparatus by a predetermined wireless data transmission system and a print processor for processing print data received by said communication processor, comprising:
an inquiry step of inquiring said information terminal apparatus existing in a range where the communication can be made by said wireless data transmission system by said communication processor together with a kind of function; and
a power control step of controlling a power supply status of a power source which is supplied to said print processor in accordance with the function kind included in a response from said information terminal apparatus to the inquiry in said inquiry step.

12. A method according to claim 11, wherein as a result of the inquiry in said inquiry step, if the existence of the information terminal apparatus of the function kind having a function to transmit data for allowing a printing process to be executed is not confirmed, in said power control step, the power supply status from a power source to said print processor is shifted to a low electric power consumption mode.

13. A method according to claim 11, further comprising a monitoring step of controlling in a manner such that as a result of the inquiry in said inquiry step, if the existence of the information terminal apparatus of the kind having a function to transmit data for allowing a printing process to be executed is not confirmed, said power control means shifts a central processing unit provided for the printer itself to a sleep status, and further, even after said central processing unit is shifted to the sleep status, the inquiry in said inquiry step is executed.

14. A method according to claim 11, further comprising an analyzing step of analyzing a profile which is sent as a response in accordance with the inquiry in said inquiry step from the information terminal apparatus existing in a range where the communication can be made in accordance with said wireless data transmission system by said communication processor,
and wherein in said power control step, the power supply status of the power source which is supplied to said print processor is controlled in accordance with a result of the analysis in said analyzing step.

15. A method according to claim 14, wherein at least a printing profile indicative of a print function is included in said profile.

16. A method according to claim 15, wherein kind information of a printer driver stored in a form such that said information terminal apparatus can execute is included in said printing profile, and in said power control step, the power control is performed in accordance with the kind information of said printer driver.

17. A method according to claim 11, wherein said inquiry step has a function for recognizing the function kind and identification information of said information terminal apparatus, in said inquiry step, a change in existence of said information terminal apparatus is recognized in accordance with identification by said identification information, and in said power control step, the power supply status from said power source to said print processor for printing said print data is shifted to a print standby mode in accordance with a result of said recognition.

18. A method according to claim 11, wherein in said power control step, as a result of the inquiry in said inquiry step, if a change in existence of said information terminal apparatus having a function for transmitting data for allowing said print control apparatus to execute the printing process is confirmed, the power supply status from said power source to said print processor for printing said print data is shifted to a print standby mode.

19. A method according to claim 11, wherein said print processor comprises: a data processor for processing the print data received by said communication processor; and a printer engine for printing and outputting the data processed by said data processor onto a recording medium.

20. A method according to claim 19, wherein said printer engine includes a printer engine of a kind of an ink jet system or an electrophotographic system.

21. A memory medium which stores program codes which are read by a print control apparatus having a communication processor for making data communication with an information terminal apparatus by a predetermined wireless data transmission system and a print processor for processing print data received by said communication processor, wherein said program codes comprise:
an inquiry step of inquiring said information terminal apparatus existing in a range where the communication can be made by said wireless data transmission system by said communication processor together with a kind of function; and
a power control step of controlling a power supply status of a power source which is supplied to said print processor in accordance with the function kind included in a result of the inquiry in said inquiry step.

22. A program which is executed by a print control apparatus having a communication processor for making data communication with an information terminal apparatus by a predetermined wireless data transmission system and a print processor for processing print data received by said communication processor, comprising:
an inquiry step of inquiring said information terminal apparatus existing in a range where the communication can be made by said wireless data transmission system by said communication processor together with a kind of function; and
a power control step of controlling a power supply status of a power source which is supplied to said print processor in accordance with the function kind included in a result of the inquiry in said inquiry step.
